(19) United States
(12) Patent Application Publication
(10) Pub. No.: US 2010/0138286 A1
(43) Pub. Date: Jun. 3, 2010

(54) SYSTEM AND METHOD FOR RENTAL OF ELECTRONIC DISPLAY SCREEN SPACE TO ADVERTISERS FOR COMPENSATION

(76) Inventors: DAVID STEINBERGER, Burlingame, CA (US); Scott Sanford, San Rafael, CA (US); Cary Etcheverry, Carson City, NV (US); Rama Notowidigdo, Palo Alto, CA (US)

Correspondence Address: PERKINS COIE LLP, P.O. BOX 1208, SEATTLE, WA, 98111-1208, US

(21) Appl. No.: 12/569,818

(22) Filed: Sep. 29, 2009

Related U.S. Application Data
(60) Provisional application No. 61/100,834, filed on Sep. 29, 2008.

(51) Int. Cl. G06Q 30/00; G06Q 10/00; G06Q 20/00

(52) U.S. Cl. 705/14.16; 705/14.23; 705/14.25; 705/14.41; 705/14.66; 705/14.69

(57) ABSTRACT

A system and method are disclosed for providing a way for advertisers to rent advertising space from a consumer on an electronic device owned or used by the consumer, such as a computer screen, television screen, or mobile telephone, and pay the consumer based upon the amount of time the consumer actively uses the device. Consumers can also receive compensation for electronic device advertising space referrals based upon the amount of time a referred consumer actively uses the device. The method further includes details regarding the compensation model.

### CROSS REFERENCES

This application claims the benefit of U.S. Provisional Application No. 61/100,834, entitled “SYSTEM AND METHOD FOR RENTAL OF ELECTRONIC DISPLAY SPACE TO ADVERTISERS FOR COMPENSATION”, filed Sep. 29, 2008, and is hereby incorporated by reference.

### TECHNICAL FIELD

The present disclosure relates to rental of electronic display screen space by consumers to advertisers in exchange for compensation.

### BACKGROUND

Advertisements are used to persuade consumers to purchase a particular product or service or to deliver an advertiser's message. Generally, advertisements are selected to be placed in locations that are easily seen or accessed, for example, on television, in magazines, and on webpages. In order to reach as many potential consumers as possible, advertisers typically pay an intermediary such as a media company or content publisher. In 2008, advertisers paid $300 billion to media companies to advertise their messages to consumers in the United States alone.

### BRIEF DESCRIPTION OF THE DRAWINGS

Examples of a system and method for rental of electronic display screen space by consumers to advertisers for compensation are illustrated in the figures. The examples and figures are illustrative rather than limiting.

FIG. 1 depicts an example block diagram of a plurality of electronic devices with displays, advertisers, a central server, and an online bank coupled via a network.

FIG. 2A depicts an example block diagram illustrating a system for receiving advertisements for displaying on consumer electronic device displays, the system to include a central server coupled to a consumer database, and advertiser database, and an advertisement database.

FIG. 2B depicts a block diagram illustrating an example of an advertisement database that stores advertisement information and advertisements.

FIG. 2C depicts a block diagram illustrating an example of an advertiser database that stores advertiser information.

FIG. 2D depicts a block diagram illustrating an example of a consumer database that stores consumer information.

FIG. 3 is a block diagram illustrating a suitable system in which aspects of the invention may operate in a network environment.

FIG. 4 depicts a flow diagram illustrating a suitable process for monitoring electronic display screen space.

FIG. 5 depicts a flow diagram illustrating a suitable process for calculating consumer compensation for renting electronic display screen space to advertisers or for recommending referrals.

FIGS. 6A and 6B depict examples of a display screen on an electronic device where a portion of the screen has been rented to advertisers.

FIG. 6C depicts an example of an advertisement viewing area on an electronic device that has been rented to advertisers.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description.

Without intent to further limit the scope of the disclosure, examples of instruments, apparatus, methods and their related results according to the embodiments of the present disclosure are given below. Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

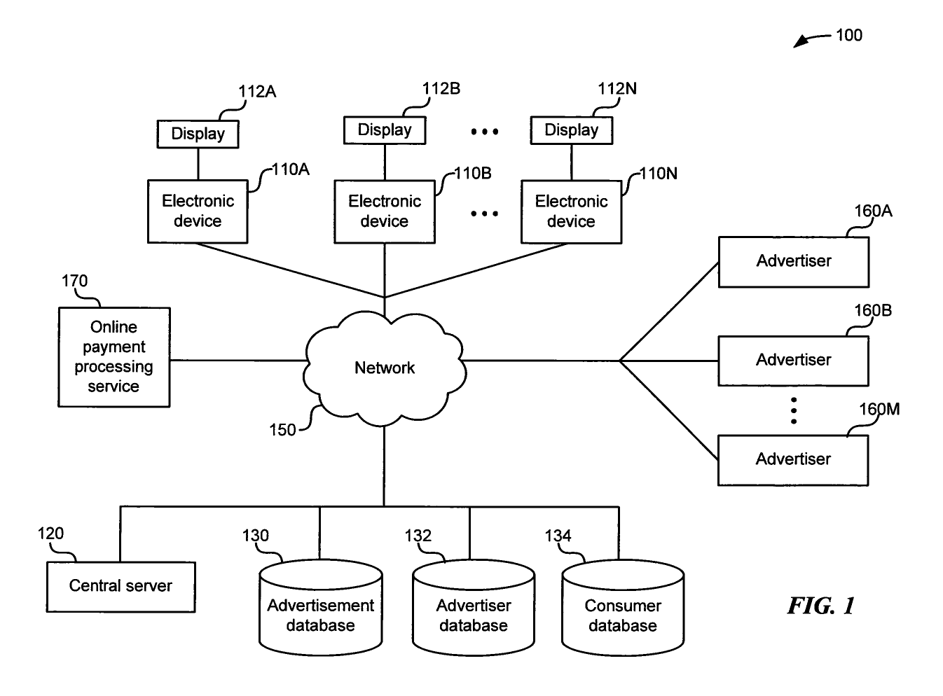

FIG. 1 depicts an example block diagram 100 of a system including a plurality of electronic devices 110A-N, each with displays 112A-N, advertisers 160A-M, a central server 120, an online bank 170, an advertisement database 130, an advertiser database 132, and a consumer database 134 coupled via a network 150, according to one embodiment.

The plurality of electronic devices 110A-N can be any system and/or device, and/or any combination of devices/systems that has an electronic display 112A-N for presenting information to a user and may establish a connection via the network 150 to the central server 120. Examples of electronic devices 110A-N include, but are not limited to, personal computers, laptop computers, computer clusters, television sets, mobile telephones, and personal digital assistants. The electronic devices 110A-N may be coupled to the network 150 by an electrical cable, an optical cable, wirelessly, or by any other method.

Users of the electronic devices 110 A-N may have the ability to download or install advertising viewing area (AVA) software. The AVA software generates an AVA that occupies a portion of the user's display screen, typically a horizontal area across the bottom of the screen, however any portion of the screen may be used as the AVA, such as the top or sides. The AVA software, once installed and registered with the central server 120, may display items such as advertising, search tools, text links, special offers, and community and viral features. Registered electronic device users automatically become members of the AVA community and will be paid for actively using their electronic devices while running the AVA. A registered user will receive additional earnings for inviting friends to become active members, thus building the user's group. A user will be paid the additional earnings when the user's group members are actively using their electronic devices while running the AVA.

The network 150 may include, but is not limited to, a telephonic network and an open network, such as the Internet. The network 150 may be any collection of distinct networks operating wholly or partially in conjunction to provide connectivity to the electronic devices and may appear as one or more networks to the serviced systems and devices. In one embodiment, communications over the network 150 may be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The advertisement database 130, advertiser database 132, and consumer database 134 may store information such as software, descriptive data, images, video, system information, and/or any other data item utilized by modules of the central server 120 for operation. The databases 130, 132, 134 may be managed by a database management system (DBMS), for example, but not limited to, Oracle, DB2, Microsoft Access, Microsoft SQL Server, PostgreSQL, MySQL, FileMaker, etc.

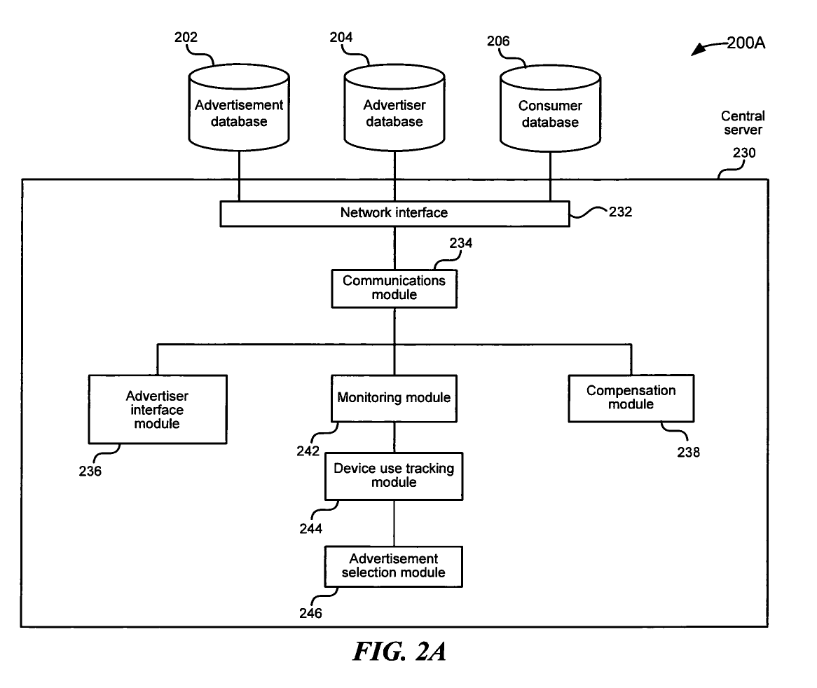

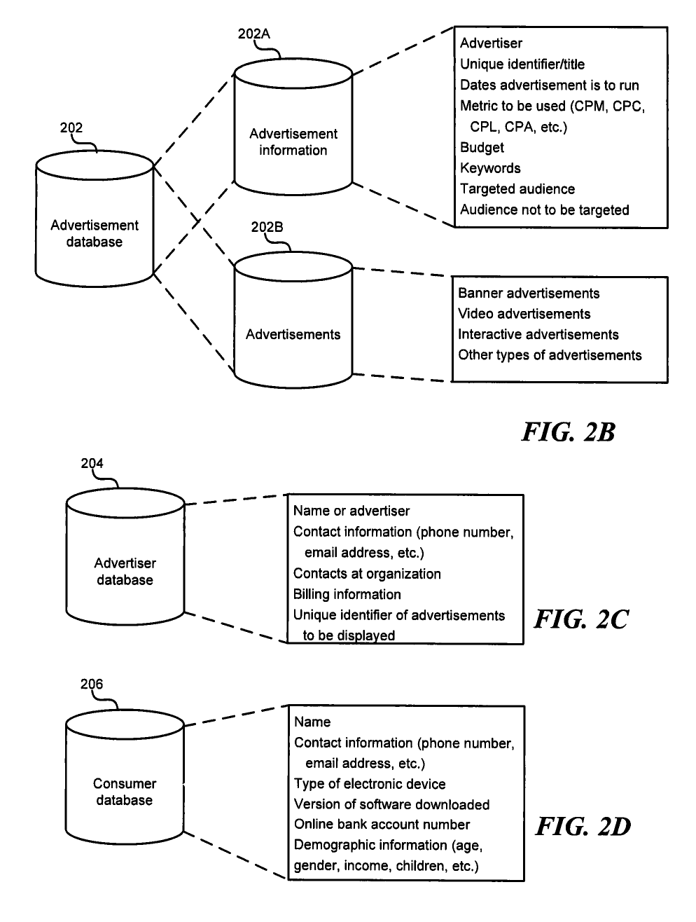

The databases 130, 132, 134 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package. An example set of data to be stored in the advertisement database 130, advertiser database 132, and consumer database 134 is further illustrated in FIGS. 2B-2D.

The central server 120 is, in some embodiments, able to communicate with electronic devices 110A-N and/or advertisers 160A-M via the network 150. Additionally, the central server 120 is able to receive advertisements including, but not limited to, video advertisements, interactive advertisements, banner advertisements, as well as advertisement information, such as presentation dates, target audience, amount of time an advertisement will be shown to a consumer, the total number of consumer impressions the advertiser wants to pay for, and payment information, from advertisers 160A-M. The central server 120 can also store and retrieve data from the databases 130, 132, 134.

In some embodiments, the central server 120 is able to monitor the consumer's use of his electronic device to determine which advertisements might be of interest to the consumer, thus allowing for targeting specific advertisements to appropriate consumers who would be more likely to purchase the advertised product or service. In some embodiments, consumers may be asked to complete a questionnaire regarding demographic information, interests, hobbies, jobs, and personal likes and dislikes in order to aid targeting of appropriate advertisements to the consumer.

Advertisers 160A-M are any entity that has products and/or services to offer and desires to display an advertising message to consumers on their electronic device displays 112A-N in exchange for providing compensation to the consumers. By directly bringing the advertising to targeted consumers and compensating the consumer for displaying the advertisements, the media company intermediaries are eliminated, and the advertiser can establish direct-to-consumer relationships to strengthen consumer loyalty and provide advertising efficiencies and cost savings. Advertisements are delivered for display on the electronic device screens 112A-N via the network 150.

The online or electronic payment processing service 170 may be any combination of software agents and/or hardware components able to conduct financial transactions through a secured website and to transfer funds to and from accounts, for example, an online banking partner, payroll cards, PayPal™, or any other solution for distribution of consumer member payments. Non-limiting examples of financial transactions include, but are not limited to, receiving deposits from advertisers into a compensation account accessible by the central server 120 and making compensation payments to consumer accounts from the compensation account as directed by the central server.

In one embodiment, the online payment service 170 may be part of a virtual mall with anchor tenants offering members discounts on products and/or services. The anchor tenants may be ones of the advertisers 160A-M, thus providing another advertising opportunity to reach consumers. In one embodiment, a percentage of any money spent at the virtual mall may be paid into the central server's compensation account for use, at least in part, for compensating consumers for actively using their electronic devices with the AVA running. In one embodiment, the anchor tenants may pay slotting fees for the right to advertise to consumers within the context of the virtual mall.

FIG. 2A depicts an example block diagram 200A illustrating a system for receiving from advertisers advertisements to be displayed on consumer electronic device displays, the system to include a central server 230 coupled to an advertisement database 202, an advertiser database 204, and a consumer database 206.

In the example of FIG. 2A, the central server 230 includes a network interface 232, firewall (not shown), communications module 234, advertiser interface module 236, monitoring module 242, device use tracking module 244, advertisement selection module 246, and a compensation module 238. Additional or fewer modules may be included. The central server 230 may be communicatively coupled to the advertisement database 202, the advertiser database 204, and/or the consumer database 206 as illustrated in FIG. 2A. In some embodiments, the advertisement database 202, the advertiser database 204, and/or the consumer database 206 are partially or wholly internal to the central server 230.

In the example of FIG. 2A, the network interface 232 can be one or more networking devices that enable the central server 230 to mediate data in a network with an entity that is external to the central server, through any known and/or convenient communications protocol supported by the central server and the external entity. The network interface 232 can include one or more of a network adaptor card, wireless network interface card, router, access point, wireless router, switch, multilayer switch, protocol converter, gateway, bridge, bridge router, hub, digital media receiver, and/or repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand. In some embodiments, the functionalities of the network interface 232 and the firewall are partially or wholly combined and the functions of which can be implemented in any combination of software and/or hardware, in part or in whole.

In the example of FIG. 2A, the central server 230 includes the communications module 234 or a combination of communications modules communicatively coupled to the network interface 232 to manage a one-way, two-way, and/or multi-way communication sessions over a plurality of communications protocols. In one embodiment, the communications module 234 receives data (e.g., video data, textual data, video files, etc.), information, commands, requests (e.g., text-based), and/or text-based messages over a network.

Since the communications module 234 is typically compatible with receiving and/or interpreting data originating from various communication protocols, the communications module 234 is able to establish parallel and/or serial communication sessions with users of remote client devices for data and command exchange (e.g., user information and/or advertising content). In addition, the communications module 234 can manage log-on requests received from one or more advertisers connecting to the central server 230 to submit advertisements or other advertisement-related information.

For example, the platform may utilize a username/email and password identification method for authorizing access. The communications module 234 can gather data to determine if the user is authorized to access the system and if so, securely logs the user into the system. In other embodiments, other forms of identity authentication, include but is not limited to, security cards and digital certificates can be utilized and are contemplated and in accordance with this disclosure. A user may be able to specify and/or obtain a logon ID after subscribing or registering.

One embodiment of the central server 230 includes an advertiser interface module 236. The advertiser interface module 236 may be any combination of software agents and/or hardware components able to interact with one or more advertisers 160A-M. The advertiser interface module 236 is, in most instances, able to query advertisers' needs, such as target audience, advertising budget, and presentation dates, and receive information in response. The module also receives different types of advertisements for display including, but not limited to, banner advertisements, interactive advertisements, and video advertisements.

One embodiment of the central server 230 includes a monitoring module 242. The monitoring module 242 may be any combination of software agents and/or hardware components able to determine when a consumer's display is active while an advertising viewing area is open and running on the consumer's screen. One method for determining whether a consumer is actively using a computer display is to track mouse movements. For example, if the mouse moves at least once per minute, the consumer's display is considered to be actively used. Other methods of tracking consumer activity on an electronic device may also be implemented. Because a consumer is compensated based upon the amount of time that the consumer actively uses the electronic device while the advertising viewing area is running, the time during which these two events occur simultaneously is recorded by the monitoring module 242 in the consumer database 206 through the communications module 234. In the above example that requires the mouse to move at least once per minute, if the mouse is stationary for longer than a minute, then active usage time stops being recorded and credited to the consumer until mouse activity is detected again.

One embodiment of the central server 230 includes a device use tracking module 244. The device use tracking module 244 may be any combination of software agents and/or hardware components able to track and store the information viewed by a consumer on the consumer's screen. For example, the consumer's internet usage may be monitored and keywords associated with webpages that the consumer visits may be recorded for use in determining the advertisements to display on the consumer's AVA. The monitoring module 242 may alert the device consumer tracking module 244 when to start tracking a consumer's activity.

In some embodiments, the device use tracking module 244, through communications with the communications module 234, may request that the consumer complete a questionnaire about preferences and interests. The gathered information is used to target specific advertisements to the consumer. In this way, the consumer receives advertisements of interest, and the advertiser reaches an audience more likely to be interested in the advertiser's products and/or services.

One embodiment of the host server 200 includes an advertisement selection module 246. The advertisement selection module 246 may be any combination of software agents and/or hardware components able to process information gathered by the device use tracking module 244 and select advertisements from the advertisement database 202 that would be suitable for presentation to the consumer. Suitable advertisements include, but are not limited to, advertisements having descriptive keywords that correspond to a consumer's interests or the keywords of the webpages that the consumer is visiting or has visited within a certain period of time in the past, for example one month.

In some embodiments, the advertisement selection module 246, through communications with the communications module 234, may be able to track whether a consumer shows an interest in an advertisement. Interest in an advertisement may be defined as when a consumer clicks on an advertisement or when a consumer buys an advertised product or service through an online transaction.

In some embodiments, the advertisement selection module 246 may track whether an advertisement has been displayed for the amount of time paid for by the advertiser. Thus, the advertisement selection module 246 may include a timer module. If a consumer stops using the display actively or the consumer turns off the advertisement viewing area while the ad is running, then in one embodiment the advertisement is considered to not have been shown, and the advertiser is not charged for the partial display of the ad.

One embodiment of the central server 230 includes a compensation module 238. The compensation module 238 may be any combination of software agents and/or hardware components able to determine the compensation earned by a consumer for using the advertising viewing area and for active referrals and determine the amount of money owed by an advertiser for the advertising services offered by the central server 230.

The compensation module 238, through communications with the communications module 234, communicates with the online payment service 170 for receiving funds from advertisers into an account maintained by the central server 230 with the online payment service. Further, the compensation module 238 also transfers money from the central server account into consumers' individual accounts. In some embodiments, consumers' compensation is calculated on a monthly basis, and the compensation is deposited into consumer's accounts monthly. However, the compensation and transfer of compensation may occur at any regular or irregular time intervals.

In some embodiments, the compensation module 238, through communications with the communications module 234, may receive referral information from a consumer. Referral information includes, but is not limited to, another consumer's name and email address or contact information. The referral information is then stored in the consumer database 206. The referring consumer receives compensation for time that the referred consumer actively uses his electronic device and also has the advertising viewing area running, and the referred consumer also receives compensation.

The central server 230 can be implemented using one or more processing units, such as server computers, UNIX workstations, personal computers, and/or other types of computes and processing devices. In the example of FIG. 2A, the central server 230 includes multiple components coupled to one another and each component is illustrated as being individual and distinct. However, in some embodiments, some or all of the components, and/or the functions represented by each of the components can be combined in any convenient and/or known manner. For example, the components of the central server may be implemented on a single computer, multiple computers, and/or in a distributed fashion.

Thus, the components of the central server 230 are functional units that may be divided over multiple computers and/or processing units. Furthermore, the functions represented by the devices can be implemented individually or in any combination thereof, in hardware, software, or a combination of hardware and software. Different and additional hardware modules and/or software agents may be included in the central server 230 without deviating from the spirit of the disclosure.

FIG. 2B depicts a block diagram illustrating an example of an advertisement database 202 that stores advertisement information 202A and advertisements 202B, according to one embodiment.

In the example of FIG. 2B, the advertisement information is stored in database 202A. Advertisement information includes data related to an advertisement including, but not limited to, the advertiser, a unique identifier/title, dates the advertisement is to run, the metric to be used (CPM (cost per thousand impressions), CPC (cost per click), CPL (cost per lead), CPA (cost per action), etc.) for determining payment, the advertising budget for the advertisement, keywords, a targeted audience, and any audience that should not be shown the advertisement.

The database 202 may also include advertisements in database 202B. Advertisements may include, but is not limited to, banner advertisements, video advertisements, and interactive advertisements.

FIG. 2C depicts a block diagram illustrating an example of an advertiser database 204 that stores advertiser information, according to one embodiment. Advertisement information includes, but is not limited to, the name of the advertiser, contact information for the advertiser, contacts at the advertiser's organization, billing information, unique identifiers for advertisements to be shown to consumers.

FIG. 2D depicts a block diagram illustrating an example of a consumer database 206 that contains information about registered consumers who have the advertisement viewing area software available on their electronic devices, according to one embodiment. Consumer information includes, but is not limited to, name, contact information such as email address, the type of electronic device that is registered (e.g. computer, mobile telephone, television), the version of the AVA software that the consumer has downloaded, an online payment account number opened for the consumer for receiving compensation, and demographic information, such as age, gender, income, number and age of children, if any.

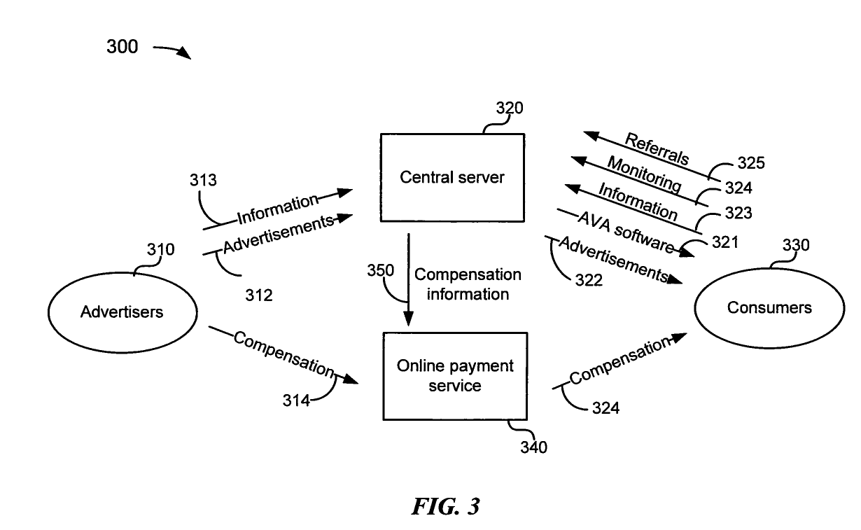

FIG. 3 depicts an example 300 of the flow of communications, including but not limited to, advertising information 313, 323, monitoring data 324, referrals, 315, and compensation information 350; AVA software 321; advertisements 312, 322; and compensation 314, 324 among advertisers 310, the central server 320, the online payment service 340, and consumers 330. The advertisers 310 may be any company, organization, entity, or individual desiring to advertise products and/or services, provide branding information, make a statement (e.g. a political statement), or convey a message (e.g. a public service message). The consumers 330 are users of electronic devices that have displays on which advertisements or messages sponsored by the advertisers may be displayed. The consumers are not necessarily the owners of the electronic devices that they use. For example, consumers may be employees of a company that owns the computers used by consumers.

The central server 320 is an intermediary between the advertisers 310 and consumers 330 and serves to provide AVA software to the consumers for running on one or more electronic devices. Further, the central server 320 registers the consumers and provides compensation to the consumers for active use of the AVA. In one embodiment, compensation may be deposited directly by the central server into consumers' online payment accounts with an online payment service 340.

The online payment service 340 can provide typical banking services, but also allows account holders to access account information and funds over the internet. Funds may also be transferred to and from accounts.

When an advertiser 310 wishes to advertise to consumers 330 using the AVA, the advertiser registers with the central server 320 to provide information 313 including, but not limited to, company name, company contact, billing information, advertisement needs such as budget, duration of advertising program, metric for advertising (e.g., number of impressions, clicks, leads, action). Additionally, advertisements 312 to be displayed are also provided to the central server 320 along with information 313 such as keywords and target audience.

With the AVA system, all advertisers pay similar time-based rates for reaching consumers by the same method. For example, a large corporation and a small local store are charged the same time-basedrate for CPM, CPC, CPL, or CPA, where the time-based rate can be expressed in amount of compensation provided to the consumer per unit of time an advertisement is displayed. As a non-limiting example, a remnant advertiser may pay $1.00 CPM for a remnant advertisement that appears on an AVA for 15 seconds, while a premium advertiser may pay $10.00 CPM, ten times as much as the remnant advertiser, for a brand advertisement to appear on an AVA for 2.5 minutes, ten times as long as the remnant advertisement appeared. In one embodiment, an advertiser can pay the owner of the central server 320 directly. Alternatively, the advertiser can maintain an account with the same online payment service 340 used by the central server 320 and transfer money from the advertiser's account into the central server's account, or the advertiser can maintain an account with any other electronic payment service and transfer money to the central server's 330 account with the online payment service 340.

Each consumer 330 who wishes to run the AVA for compensation must first register with the central server 320 and provide information 323 including, but not limited to, name, email address, contact information. In exchange, the central server 320 provides the AVA software 321 for installing on the consumer's electronic device.

In some embodiments, the consumer may be asked for information 323 including, but not limited to, interests, hobbies, shopping habits, demographics, etc. This information may be used by the central server 320 to decide which advertisements to display in the AVA of the consumer's electronic device.

Once the consumer has installed the AVA software on an electronic device, the central server 320 begins delivering advertisements 322. The central server 320 monitors the consumer's use of the electronic device and the AVA. Monitoring data 324 is sent back to the central server 320 over the internet. Monitoring data includes, but is not limited to, whether the electronic device is actively being used, the types of applications the consumer is running on the electronic device, and information about websites that the consumer visits such as keywords or advertisements displayed on the website.

Consumers may also make referrals of other potential consumers to the central server 320. A direct referral is called a first degree referral. A consumer (person A) makes a referral by providing the name and email address or contact information 325 of the referral consumer (person B) to the central server 320. If person B registers and runs the AVA while actively using his electronic device, person A will receive compensation at a certain rate for person B's active usage time, and person B, the referred consumer, also receives compensation for the active usage time. The two compensation rates may or may not be the same. In some embodiments, there may be a cap on the maximum number of hours that the referring consumer and the referred consumer may be compensated for. The maximum usage time that will be compensated may or may not be the same for the two consumers.

Additionally, person B, the first degree referral of person A, may make a first degree referral of his own (person C). Person C is considered a second degree referral to person A. In this case, if person C registers and runs the AVA while actively using his electronic device, person A may receive compensation at a first rate (rate X), person B may receive compensation at a second rate (rate Y), and person C will receive compensation at a third rate (rate Z). The rates X, Y, and Z may or may not be the same. In some embodiments, there may be a cap on the maximum number of hours that persons A, B, and C may be compensated for. The maximum time limit may or may not be the same for the three consumers.

The central server 320 distributes information to the consumers 330 regarding the compensation rates, the maximum creditable usage time, and the highest degree of referral for which compensation will be provided. The central server 320 calculates the compensation owed to a consumer after taking into account usage time, compensation rates, and compensable degree of referrals and provides the compensation information 350 to the online payment service 340. The online payment service is then authorized to transfer the money from the central server's account to the particular consumer's account.

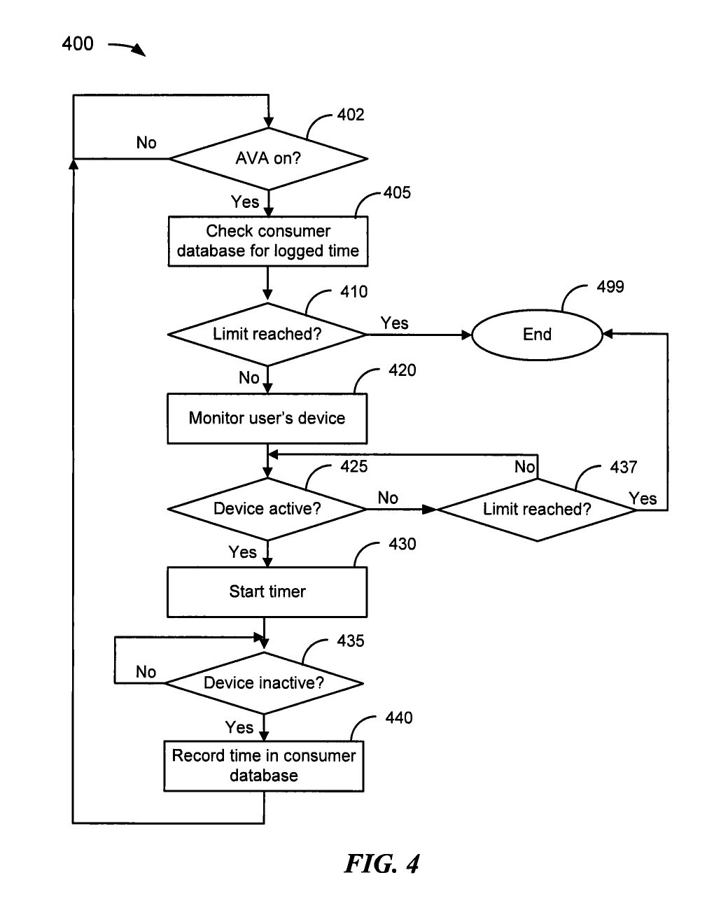

FIG. 4 depicts a flow diagram 400 illustrating a suitable process for monitoring electronic display screen space, according to one embodiment.

At decision block 402, the system determines whether the advertising viewing area (AVA) is on and running on a consumer's electronic device screen. If the AVA is not on (block 402—No), the system keeps checking at block 402 for the AVA to be turned on.

If the AVA is on (block 402—Yes), at block 405 the system checks the consumer's record in the consumer database for the amount of time that the consumer has been running the AVA while actively using the electronic display. The system determines if the consumer has reached the maximum period of time for which compensation is available at decision block 410. The maximum period of compensation is adjustable by the system administrator and may be changed upon giving notice to participating members. As a non-limiting example, a cap of 20 hours of active time per month may be logged by each consumer for compensation purposes. A consumer may choose to run the AVA beyond the 20 hour compensation limit, but the consumer will not receive compensation for any additional time. If the limit has been reached by the consumer (block 410—Yes), the process ends at block 499. If the limit has not been reached by the consumer (block 410—No), at block 420, the system monitors the consumer's use of the participating electronic device for active use.

At decision block 425, the system determines if the consumer's electronic device is active. The consumer must actively be using the electronic device on which the AVA is running or credit will not be given for operation of the AVA. Thus, a consumer may not leave a computer running with the AVA running without actually being present because the advertiser will not get the benefit of reaching the consumer. If the electronic device is not active (block 425—No), the system keeps checking for activity. If the system detects activity (block 425—Yes), the system starts a timer at block 430.

At decision block 435, the system determines when the consumer's device reaches an inactive state. If the device remains active (block 435—No), at decision block 437, the system checks if the consumer has reached the maximum period of time for which compensation is available. If the limit has been reached by the consumer (block 437—Yes), the process ends at block 499. If the limit has not been reached by the consumer (block 437—No), at block 420 the system returns to decision block 435 to check whether the consumer's device has reached an inactive state. If the device becomes inactive (block 435—Yes), at block 440, the system stops the timer and records the elapsed time in the consumer database to credit the consumer for the active use of the electronic device while simultaneously running the AVA. The process returns to decision block 402 to determine the next time that the AVA is turned on.

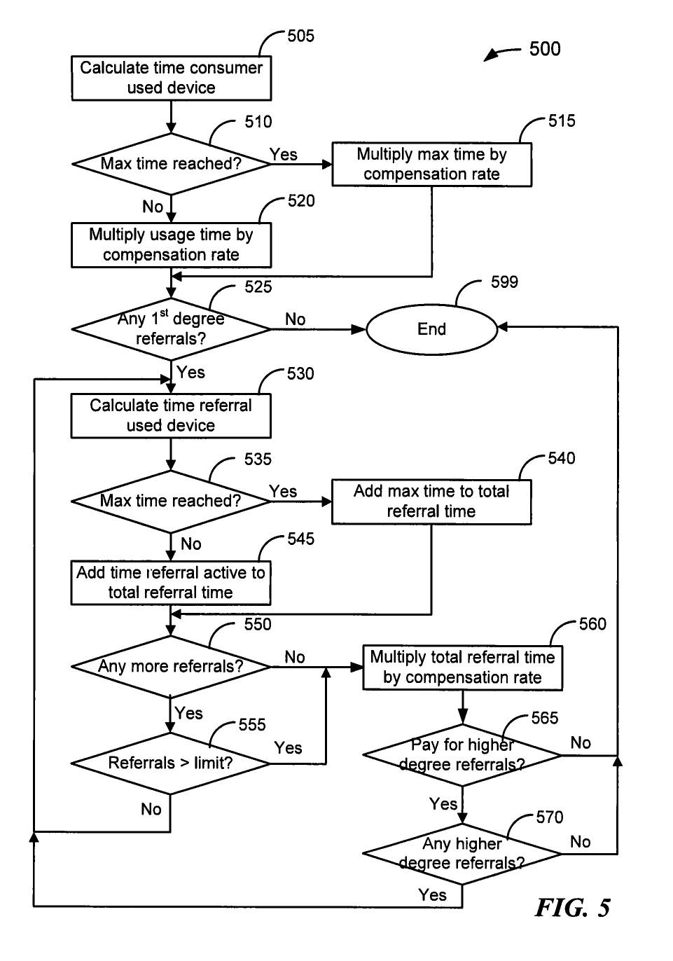

FIG. 5 depicts a flow diagram 500 illustrating a suitable process for calculating consumer compensation for renting electronic display screen space to advertisers or for recommending referrals, according to one embodiment.

At block 505, the system accesses a consumer's record in the consumer database 206 and calculates the total time that the consumer used a registered electronic device while running the AVA. Generally, the calculation will only include the credited time for a given time period. For example, if compensation is paid out monthly, then only creditable time logged since the last compensation period will be included. Note that compensation may be made at any regular or irregular interval. In either case, only time credited since the last compensation time will be included. Next, at decision block 510, the system determines if the consumer has reached the maximum amount of time that is permitted to be compensated. If the maximum usage time has been reached (block 510—Yes), the maximum time limit is multiplied by the base compensation rate. For example, if 20 hours is the maximum time for which a consumer may be compensated for a month, and the base compensation rate is $0.05 per hour, then the consumer will be compensated a total of $1.00 for the current month. The process continues to decision block 525 as described below.

If the consumer's accumulated usage time has not reached the maximum time limit (block 510—No), at block 520, the accumulated usage time is multiplied by the base compensation rate. For example, if the consumer only accumulated a usage time of 10 hours, using a base compensation rate of $0.05 per hour, the consumer will receive $0.50 for the current month. In one embodiment, tiered compensation rates may be used such that the compensation rate changes depending upon the total usage time.

At decision block 525, the system determines whether the consumer, referred to as the primary consumer for clarity, has made any first degree referrals of other consumers for running the AVA on an electronic device screen. A first degree referral is a direct referral of another consumer by the primary consumer, and a referral requires that the primary consumer provide a minimum of a name and contact information such as an email address. In some embodiments, other criteria may apply, for example, if a referral has already registered to use the AVA software or has previously been referred by another consumer, then no credit is given to the second referring consumer. If the primary consumer has not made any referrals (block 525—No), the process ends at block 599.

If the primary consumer has made at least one first degree referral, at block 530 the system accesses the first degree referral consumer's record in the consumer database and calculates the total time that the referral consumer used a registered electronic device while running the AVA, similar to block 505, but applied to the referral consumer.

Then at decision block 535, the system determines if the consumer has reached the maximum amount of time that is compensable for a first degree referral. If the maximum accumulated time has been reached (block 535—Yes), the maximum time limit is added to the running total referral time for that degree of referral. In this case, the running total referral time is for first degree referrals. The process continues at decision block 550 described below.

If the maximum accumulated time has not been reached (block 535—No), at block 545 the usage time is added to the running total referral time. For example, if the running total referral time is 140 hours, and this particular referral has accumulated 15 hours of usage time, then the running total referral time becomes 155 hours.

At decision block 550, the system determines whether the primary consumer made any more referrals of the same degree. In this case, we are looking at first degree referral consumers. If no more first degree referrals have been made (block 550—No), at block 560 the system multiplies the running total active time for first degree referrals by the first degree referral compensation rate. For example, if the primary consumer had ten first degree referrals, the running total active time for these ten first degree referrals is 150 hours, and the first degree referral compensation rate is $0.02 per hour, the total compensation the primary consumer earns from his first degree referrals is $3.00.

Proceeding to decision block 565, the system determines whether the primary consumer is paid for higher degree referrals. In this case, the next higher degree referral is a second degree referral. A second degree referral is when a first degree referral of the primary consumer makes a first degree referral of his own. In this example, the primary consumer earns some compensation for active usage time of the second degree referral consumer. If the system does not pay for a higher degree referral (block 565—No), the process ends at block 599.

If the system does pay for higher degree referrals (block 565—Yes), at decision block 570, the system determines if the primary consumer has made any higher degree referrals. In this case, the system determines if the primary consumer's first degree referrals have themselves made any first degree referrals. If no higher degree referrals have been made (block 570—No), the process ends at block 599. If higher degree referrals have been made (block 570—Yes), the system returns to block 530 to access one of the first degree referral consumer's record in the consumer database 206 to find a referral and calculate the total time that the second degree referral consumer used a registered electronic device while running the AVA, similar to block 505, but applied to the second degree referral consumer.

The process continues to decision block 535, as before. It should be noted that the maximum usage limit for a second degree referral may or may not be the same as for a first degree referral. Further, the compensation rate paid to the primary consumer for active usage time of the AVA for a second degree referral may or may not be the same as for a first degree referral.

If at decision block 550, more referrals have been made by the primary consumer that have not been included in the running total active time for first degree referrals (block 550—Yes), at decision block 555, the system determines if the number of first degree referrals made by the primary consumer is greater than the maximum number of referrals that the system will compensate the primary consumer for. If the limit has been reached (block 555—Yes), the process continues to block 560, as before. If the limit has not been reached (block 555—No), the process continues to block 530, as before.

An example of network payout to a primary consumer for up to third degree referrals is shown in Table 1. In this example, it is assumed that each person in a particular group (first, second, or third degree referrals) each actively uses the AVA for 20 hours. The total payout to the primary consumer in this case would be $489.00.

TABLE 1

| | No. people in group | Hours | Rate | Earnings |
|---|---|---|---|---|
| primary consumer | 1 | 20 | $0.05 | $1.00 |
| first degree referrals | 20 | 20 | $0.02 | $8.00 |
| second degree referrals | 200 | 20 | $0.02 | $80.00 |
| third degree referrals | 1000 | 20 | $0.02 | $400.00 |

In some embodiments, additional payment opportunities may be made available to members including, but not limited to, responding to research surveys, sampling, couponing, group buying, and subscription incentives. These payment opportunities may differ from the collectively shared advertising revenue model by providing payment opportunities to individual users for providing personal information, participating in marketing promotions, or completing a purchase.

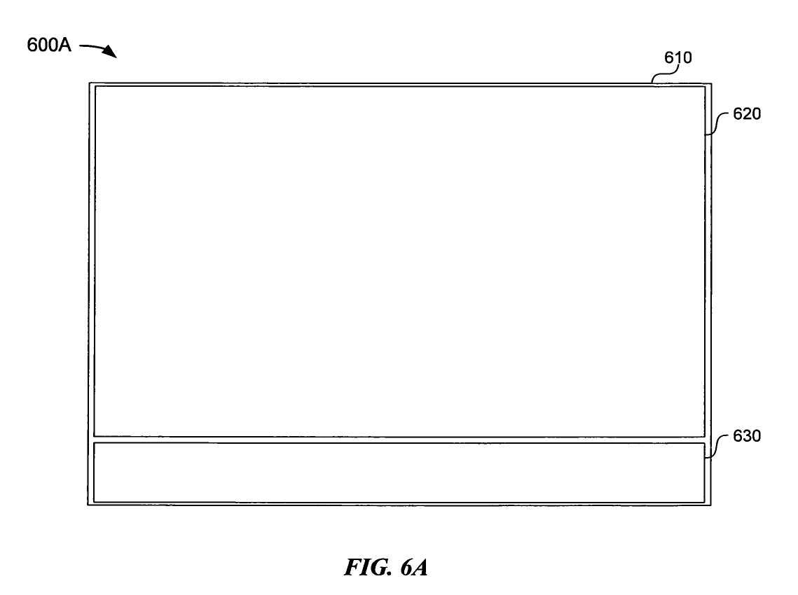

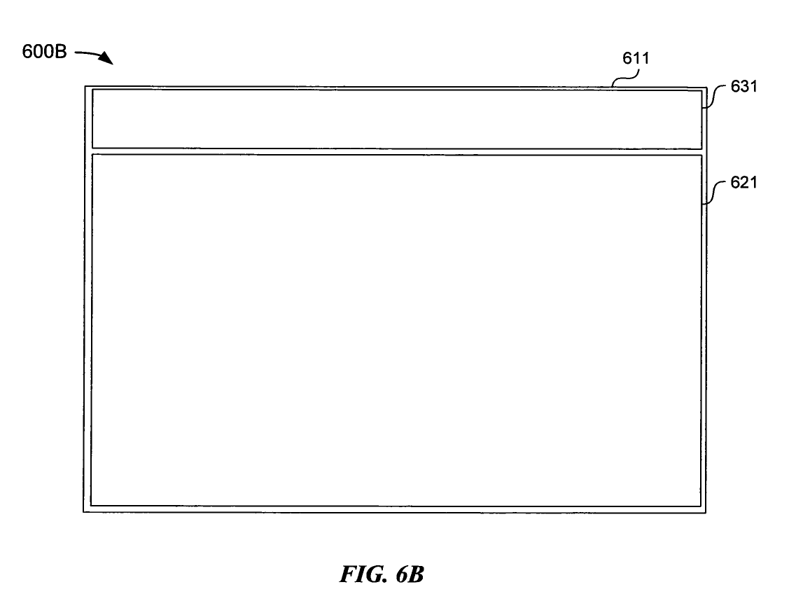

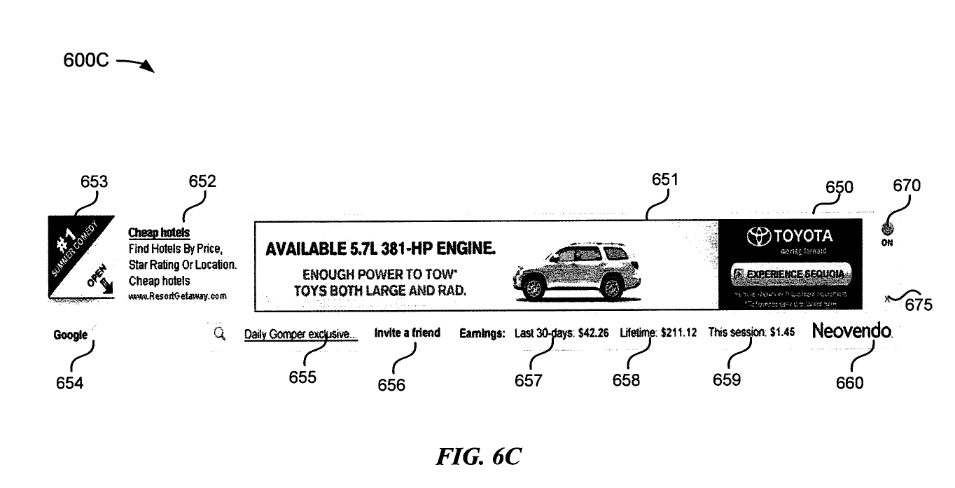

FIGS. 6A and 6B depict examples 600A, 600B of a display screen 610, 611 on an electronic device where a portion 630, 631 of the screen has been rented to advertisers, according to one embodiment.

In FIG. 6A, the total display screen area of a consumer's electronic device is indicated by element 610. The screen is divided into two portions, the top portion 620 which is used the way the consumer would usually use the screen. For example, in the specific case of a computer display, whether a laptop or a desktop computer, the consumer may run software applications, use one or more internet browsing windows, play games, watch a video, etc. The bottom portion 630 of the screen is used by the central server to deliver advertisements and other related information to the consumer and is referred to as the advertisement viewing area. One or more advertisements may be displayed, and the advertisements may also be interactive. In one embodiment, the advertisement viewing area is located at the bottom of the screen 610. However, the advertisement viewing area may be located at any position on the screen, for example, at the top of the screen 631 as shown in FIG. 6B. In one embodiment, the AVA can even periodically or randomly shift to any location on the screen. Because the placement of the AVA is on the screen, rather than a webpage, the AVA cannot be scrolled off the screen.

FIG. 6C depicts an example 600C of an advertisement viewing area 650 on an electronic device that has been rented to advertisers, according to one embodiment. It will be appreciated by a person skilled in the art that the display may incorporate different advertisements and information in a different format from that shown.

In the example of FIG. 6C, the large window 651 displays and highlights a leaderboard advertisement. The advertisement may contain pictures, words, and/or video. The advertisement may be broken up into several small advertisements from the same advertiser advertising different aspects of a single product or service or different products or services.

The smaller window 652 may provide contextually relevant text links. For example, in window 652 the text advertisement for a website advertising hotels is displayed.

The corner window 653 may provide a rich media expanding advertisement unit. By clicking on the window, the advertisement expands into a larger advertisement on the screen and allows active participation by the consumer.

On the bottom row of the AVA 650, relevant information may be displayed for the consumer's convenience. For example, box 654 contains a search box powered by a search engine, for example Google. The box 655 provides a link to deals for members who use the AVA software, such as ways to make or save money. The money making and saving methods may be related to advertisements shown in the advertising viewing area 650. In one embodiment, the deals may be exclusive to AVA software users.

A box 656 may provide a link for inviting a friend to become a member. Friends who register, install the AVA software onto an electronic device, and actively use the device while running the AVA will become a first degree referral to the referring consumer.

Boxes 657, 658, and 659 show the earnings of the consumer. Box 657 indicates the earnings of the consumer over the last 30 days, box 658 shows the consumer's total earnings to date since installing and using the AVA software, and box 659 shown the earnings of the consumer during the current session that the consumer is using his electronic device. Earnings accumulated over other time periods can also be shown in these boxes. All earning totals include compensation from the consumer's own use as well as any referrals of all compensable degrees.

Box 660 is a link to a website that provides member account tools for the consumer including, but not limited to, changing contact information, adding a referral, and requesting software updates.

Indicator 670 shows when the AVA is running and the consumer is earning money. If the consumer clicks on button 675, it closes the AVA and removes it from the screen. The screen space reverts to its original use as part of the consumer's electronic device display.

Many other types of messages may also be displayed in the AVA. For example, a church or school group may post a message on the AVA encouraging all members, and even non-members, to actively use the AVA for the next month. Arrangements could be made to have all compensation to be paid to participants for that next month to be deposited into an online account accessible by the church or school.

In some embodiments, other sponsorship opportunities are available to advertisers. An advertiser may request a custom-designed skin for the AVA in particular versions of the AVA software. For example, the manufacturer of a soft drink may request that the AVA be made to resemble the distinctive look and shape of the manufacturer's soft drink bottle. The custom-designed skin may also be targeted at particular market segments, such as college students. Or even more specifically, college students may be targeted during final exam week, and the special custom skin would only be used for limited times during the day so that the student consumers' attention is captured and focused on the advertisements.

In one embodiment, the electronic device can have the capability of offering an expandable area within the AVA. An advertiser could purchase an expandable sponsorship unit which, upon a user's mouse-over, would expand to provide a larger advertising canvas, beyond the walls of the AVA. The electronic device can also have the capability to display, rotate, and/or target special limited time offers available for a specific period of time. For example, a car dealer may wish to display a special offer at the end of the month to users who have indicated they are planning to buy a car, and a retailer could offer special one-hour sales on overstocked items at special discounts for members. Payment for products could be transferred from the user's account, if applicable.

While the above description has focused on placement of the AVA on computer screens, in one embodiment, the AVA may also be placed on a mobile telephone screen. Modifications may be made to the AVA to accommodate the correspondingly smaller available screen space. For example, an AVA browser can be downloaded to a mobile telephone, such as an iPhone, that allows the user to sign in and surf the internet using a registered account. The AVA browser would display advertising in a particular location on the screen, such as at the bottom of the screen. The mobile telephone account can be linked to the user's account for receiving compensation payments, where the same account is linked to the user's other registered electronic devices. Then the user can receive credit for actively using any of the linked electronic devices while the AVA is running, but the user would only receive credit for actively using one of the linked electronic devices at any given time. Similarly, the AVA may also be adapted for use on a television screen.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this patent application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A system, comprising:
a consumer database, wherein information pertaining to registered consumers are stored in the consumer database;
an advertiser database, wherein information pertaining to registered advertisers are stored in the advertiser database; and
a server coupled to the consumer database and the advertiser database, wherein the server is further coupled among at least one source of advertisements and multiple electronic devices with screens, via a network, and further wherein the server is configured to:
receive advertisements from the at least one advertisement source;
receive payments from advertisers providing the advertisements;
display at least a subset of the advertisements on advertising viewing areas (AVA) of the screens;
monitor use of the electronic devices to determine an active use time of the electronic devices while advertisements are displayed on the screens; and
provide compensation to registered consumers associated with the electronic devices based at least upon the active use time.

2. The system of claim 1 wherein the server is further configured to display a plurality of different advertisements simultaneously on the AVA.

3. The system of claim 1 wherein the server is further configured to use consumer information in the consumer database to target advertisements shown on the AVA.

4. The system of claim 1 wherein the payments from the advertisers are deposited into a first account associated with an electronic payment processing entity, and the compensation provided to registered consumers are taken from the first account, and further wherein each registered consumer has a consumer account associated with the electronic payment processing entity, and the compensation is deposited into the consumer account.

5. The system of claim 4, wherein the electronic payment processing entity is further associated with premium advertisers of a virtual mall that offer registered consumers discounts on products or services.

6. The system of claim 1 wherein payments from advertisers are based at least upon a total amount of time that a particular advertisement is displayed on all AVAs.

7. The system of claim 1 wherein the server is further configured to receive a referral from a registered consumer, and further wherein the registered consumer receives additional compensation based at least upon the active use time of the referral.

8. A method, comprising:
receiving a first request from a consumer to rent advertising space on a screen of an electronic device used by a consumer in exchange for compensation;
receiving a second request from one or more advertisers to display one or more advertisements on the consumer's electronic device screen;
displaying at least a subset of the one or more advertisements in an advertising viewing area (AVA) on the electronic device screen;
tracking use of the electronic device to determine an active use time of the electronic device while advertisements are displayed on the AVA;
receiving a payment from the advertisers for displaying each advertisement; and
delivering a compensation to the consumer, wherein the compensation is dependent upon an amount of time that the consumer actively uses the electronic device.

9. The method of claim 8 wherein delivering a compensation comprises depositing the compensation into an online bank account or delivering the compensation by an alternate method of distribution

10. The method of claim 8 wherein the AVA is fixed at the top, bottom, side, or a corner of the screen.

11. The method of claim 8 wherein the AVA moves to different locations on the screen periodically or at random intervals.

12. The method of claim 8 wherein the AVA has a custom-designed skin for a particular advertiser.

13. The method of claim 8 wherein the AVA has a plurality of windows for displaying a plurality of advertisements at the same time.

14. The method of claim 8 wherein the AVA displays information related to the compensation while displaying advertisements.

15. The method of claim 8 wherein the consumer can close the AVA at will and stop earning the compensation.

16. The method of claim 8 wherein the consumer can select a first advertisement on the AVA, and upon selection, the first advertisement expands into a larger advertisement that exceeds the bounds of the AVA.

17. A method comprising:
providing advertising viewing software for loading onto a first electronic device with a first screen;
monitoring the first electronic device for a first active use while an advertising viewing area (AVA) displays advertisements on the first screen;
timing a first active use time; and
providing a first compensation to a first consumer based upon at least the first active use time of the first electronic device.

18. The method of claim 17, further comprising:
providing advertising viewing software for loading onto a second electronic device with a second screen;
monitoring the second electronic device for a second active use while an advertising viewing area (AVA) displays advertisements on the second screen;
timing a second active use time;
providing a second compensation to a second consumer based at least upon the second active use time of the second electronic device, wherein the second consumer was referred by the first consumer; and
providing a third compensation to the first consumer based at least upon the second active use time.

19. The method of claim 17, further comprising:
providing additional compensation to the first consumer for additional referrals made by the second consumer, wherein the additional compensation is based at least upon additional active use time of the additional referrals.

20. The method of claim 17, further comprising:
receiving a message from an entity for posting on the AVA, wherein the message encourages consumers to contribute compensation to a cause for a period of time;
registering interested consumers; and
depositing a total compensation of each interested consumer for the period of time into an account associated with the cause.
